(19) United States
(12) Patent Application Publication
(10) Pub. No.: US 2016/0140945 A1
(43) Pub. Date: May 19, 2016

(54) Electronic Musical Instrument Percussion System with Electromagnetic Sensor

(71) Applicant: PARSEK LAB S.R.L., San Giovanni Teatino (IT)

(72) Inventors: Marco DE VIRGILIIS, Citta Santangelo (IT); Pietro GELOSO, Chieti (IT); Sisinio OLIVASTRI, Lanciano (IT); Marco CARAMANICO, Casalincontrada (IT)

(73) Assignee: PARSEK LAB S.r.l., SAN GIOVANNI TEATINO (IT)

(21) Appl. No.: 14/900,172

(22) PCT Filed: Dec. 13, 2013
(86) PCT No.: PCT/IT2013/000348

§ 371 Date: Dec. 20, 2015

(30) Foreign Application Priority Data
Jun. 21, 2013 (IT) PE2013A000007

(51) Int. Cl. G10H 3/14; G10D 13/02

(52) U.S. Cl. CPC G10H 3/146; G10D 13/024

(57) ABSTRACT

The present invention relates to electronic percussion musical instrument system, and particularly to an electronic drum, which comprises one or more electronic control units to generate sounds. The system has an upper surface, which receives the percussion and is covered by a rubber layer useful for giving a realistic rebound to the musician, a lower surface and an electromagnetic sensor operating according to the Faraday-Neumann-Lentz physics law, which has a magnet placed in adherence to the upper surface and a bobbin applied to the lower surface, and a shock absorber spacer arranged between the two surfaces to allow the two components of the electromagnetic sensor to remain in reciprocal suspension.

The present invention relates to a detection apparatus for detecting percussion in an electronic percussion instrument system, based on a sensor built according to the Faraday-Neumann-Lentz (FNL) physics law, and applies, by way of example so not exclusively, to an electronic drum, which comprises one or more electronic control units to generate sounds, or rather, still as an example, in other electronic musical instruments hit by hand or other objects, such as the ‘bongo’ or the ‘kettledrum’.

Every electronic percussion instrument is based on the detection of the stroke and the transduction of the electrical signal to the generation of a sound through one or more electronic control units. This invention allows a better detection of the percussion, simplifying it, and therefore making it accessible to any electronic percussion instrument.

In the present state of the technique, electronic percussion instruments are made out from individual instruments connected to an electronic control unit. Referring specifically to the electronic drum, the individual instruments (snare-drum, tom-tom, cymbals, etc.) are connected to an electronic control unit.

On electronic percussion instruments, below the surface that is struck, sensors are applied to detect the vibrations produced. These are transduced into electric impulse which is analysed by the electronic control unit in order to determine the musician's stroke to then generate the relative sound.

The most widely used vibration sensor is the piezoelectric sensor, which is easy to find on the market and is applied in adhesion to the struck surface of the electronic percussion instrument.

This sensor, in order to detect the stroke and translate it into an electric signal, must adhere to the surface that is struck. For example, in the case of the electronic drum, the piezoelectric sensor must be placed on the underside of the natural or synthetic skin of the drum. A piezoelectric sensor is not usually the same size as the surface being struck; it is in fact smaller and it is sufficient to hit any part of the surface for the piezoelectric sensor to pick up the vibration.

All this is common knowledge and fully described in the U.S. Pat. No. 6,921,857 B2 and U.S. Pat. No. 6,121,538.

Therefore, an electronic percussion instrument system that uses a piezoelectric sensor requires that said sensor is in direct contact with the struck surface and this causes to several downsides and limitations described below.

The so-called ‘hot spot’ is the typical problem of all electronic percussion musical instruments with piezoelectric sensors and consists of the effect generated when the exact position of the surface of the musical instrument which is in direct contact with the piezoelectric sensor is hit, such an effect being characterized by a higher peak value, the so-called ‘hot spot’, with respect to the surrounding areas. In this specific case, the piezoelectric sensor detects the direct hit and transforms it into a peak value electric signal which is transmitted to the electronic control unit to generate the sound. The musical instrument, therefore, will give unnatural peaks of volume when hit on or in the immediate vicinity of the sensor. This represents one of the major technological limits which differentiates the original musical instrument from the electronic one.

Moreover, the piezoelectric sensor is made of a ceramic material that makes the sensor particularly fragile for the use in an electronic percussion musical instrument. In fact, the design and the manufacture of an electronic musical instrument requires some precautions and specific techniques in order to avoid the breaking of the sensor due to direct hits on it.

In order to solve the two technical limitations mentioned above, layers of rubber are used, or other types of material that are elastic or rigid, protective, necessary and suitable for absorbing the hits in order to avoid that the percussion is given directly onto the piezoelectric sensor and suitable also for spreading the force generated over the entire surface of the musical instrument in case the hit occurs in the position where the piezoelectric sensor adheres.

Finally, from an electrical point of view, the piezoelectric sensor has a high output impedance and this makes it sensitive to electromagnetic interference. It is therefore necessary to take certain precautions, such as shielded cables and specific circuits for handling the piezoelectric signals.

Due to the limitations pointed out, the surfaces of electronic percussion instruments are currently build in such a way as to have, in addition to the function of transmitting the force generated by the stroke, the primary function of protecting the piezoelectric sensor beneath with the aim of reducing the peak generated by the so-called ‘hot spot’ and also protecting the piezoelectric sensor from a direct hit, as well as shielding it from electromagnetic sources.

The aim of the present invention is to improve the detection of the stroke and consequently improve and simplify the whole sound generating system of electronic percussion musical instruments, in order to overcome the inconveniences indicated and therefore ensuring that the surface that is hit maintains exclusively the stroke detection function, to overcome the hot spot technical limit and to reduce the function of protecting the structural and electromagnetic fragility of the sensor beneath, which can then be positioned in any position under, on the side or even above the instrument's surface to be struck, thus giving a major efficiency since it is able to cancel and eliminate the so-called hot spot technical problem.

In this way it will be even easier to manufacture an electronic percussion musical instrument.

According to the present invention, there is provided an electronic percussion musical instrument system according to the appended claims.

The present invention will now be described with reference to the accompanying drawings, which show a non-limiting embodiment thereof, wherein:

FIG. 1 shows a section view of a part of the electronic percussion musical instrument system according to the present invention;

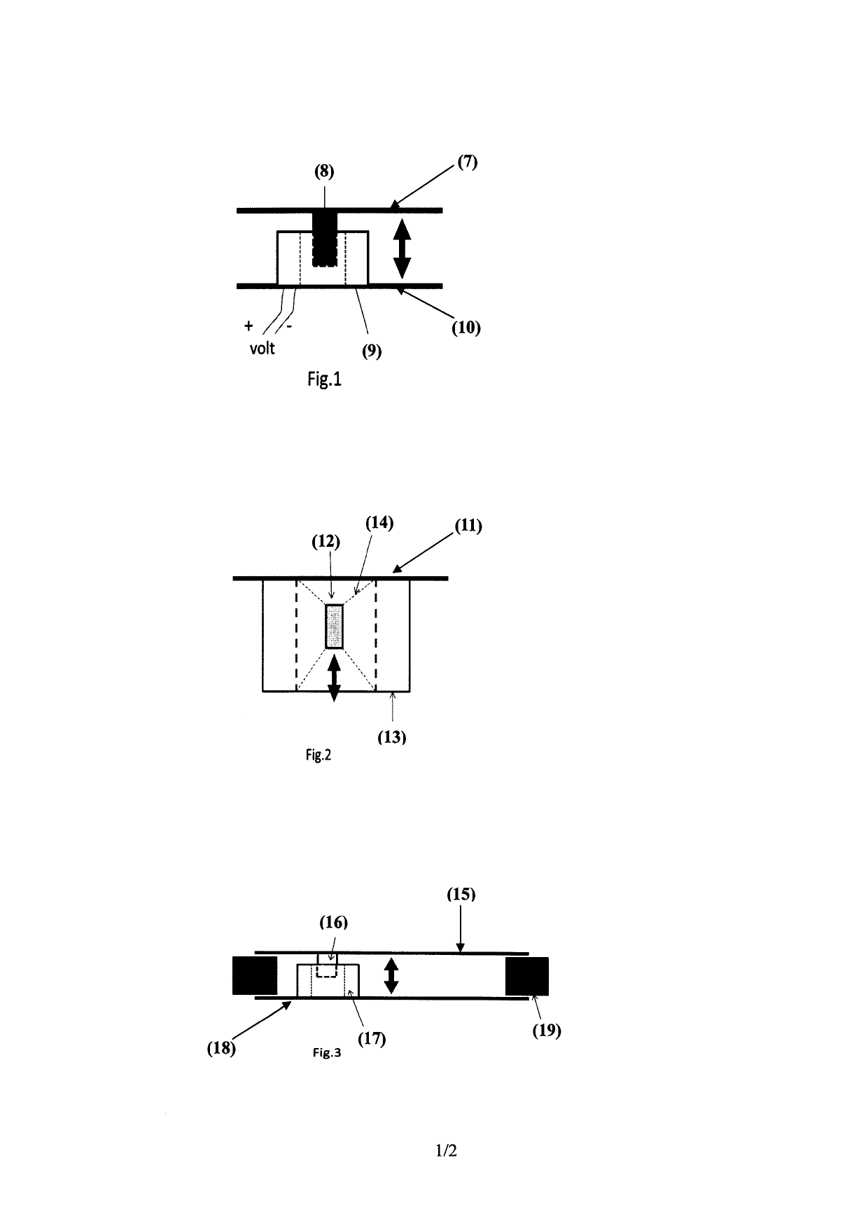

FIGS. 2 and 3 show two different embodiments of the part of FIG. 1;

FIG. 4 shows two different perspective views of a sensor of the part of FIG. 1; and

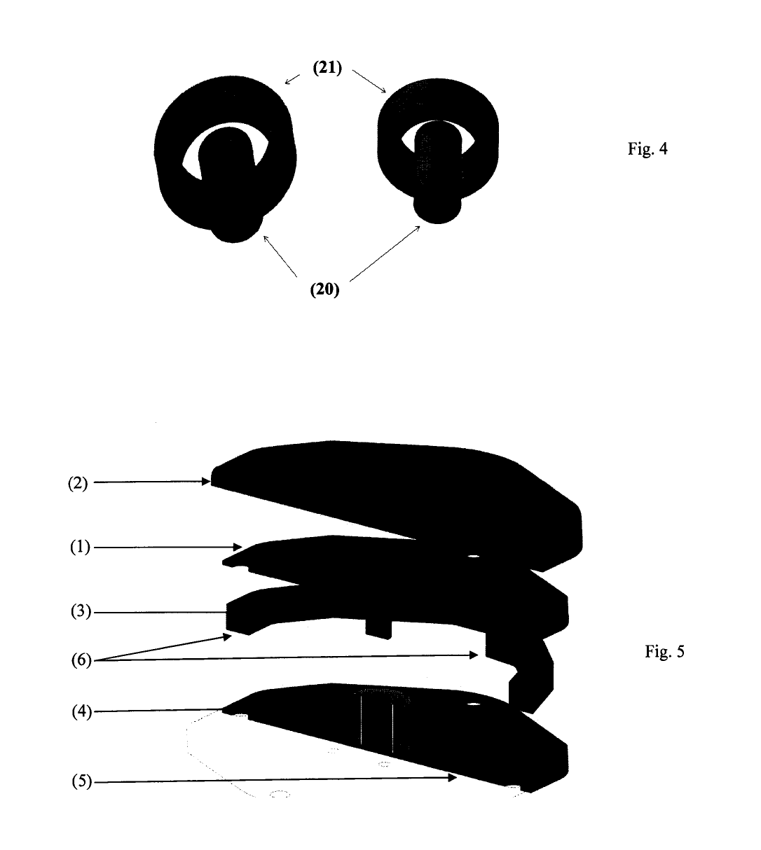

FIG. 5 shows a perspective and exploded view of an embodiment of the electronic percussion musical instrument system according to the present invention.

According to the invention, the electronic percussion musical instrument system is obtained by applying of one or more vibration detection sensors based on the Faraday-Neumann-Lentz (FNL) physics law. It can be used in every electronic percussion instrument such as the so-called snare drum, tom-tom, cymbal, Hi-hat, bass drum, kettledrum, bongo, etc. . . .

An electronic percussion instrument built according to this invention offers a series of advantages.

Firstly, the FNL sensor reduces drastically the hot spot problem with the piezoelectric sensor since it is much less sensitive to a deformation of an instrument's surface to which it is connected. Consequently, if the surface of an electronic percussion instrument is hit on the exact point in which the FNL sensor is positioned or in any other part of the surface, with the same intensity of stroke, there will be a uniformity of the sound generated without signal peaks and, most of all, with a musical result even more similar to a real instrument, unlike with the use of a piezoelectric sensor. Secondly, a FNL sensor (so-called electromagnetic sensor) has a greater mechanical solidity in comparison with its piezoelectric equivalent since the interior component is built from a magnet, whereas the exterior one is built from a copper bobbin (that is a coil of copper wires). This kind of structure typology is extremely resistant to shocks and shows no evidence of fragility as occurs with piezoelectric sensors that have a ceramic structure.

A FNL sensor can be made in a great variety of shapes and dimensions (e.g. round, square, hexagonal, etc.) in order to adapt both to the fullness of vibrations from the strokes to be detected, as well as the geometry of percussion instruments (snare drum, tom-tom, cymbals, bass drum but also struck by hand percussion instruments such as bongos, etc.).

Finally, from an electric point of view, there is also the advantage of having a sensor with a very low output impedance which simplifies the following elaboration of the electric signal. This translates into a circuit configuration of simplified interfacing and a greater immunity to interference that may be induced in the interconnection between the circuit that receives the sensor signal and the sensor itself. This allows the use of connecting cables not specialized and not shielded and the complete elimination of interference induced by a sensor-circuit connection, as that experienced particularly by piezoelectric sensors. Ultimately, the mechanical vibrations the cable picks up are transduced by the piezoelectric sensor into spurious signals, whereas in the case of the use of an FNL sensor the mechanical vibrations of the cable are not picked up.

The proposed sensor is based on the Faraday-Neumann-Lentz (acronym FNL) physics principle which describes the generation of an electric tension in a bobbin 21 when a magnet 20 (or a second bobbin) within the bobbin changes position (FIG. 4) due to, in our case, the vibrations produced by the percussion stroke, thus varying the concatenated magnetic flux. The principle is used to create and utilize a vibration sensor (trigger) in any electronic percussion musical instrument.

The electronic percussion musical instrument comprises an upper surface 7, which is struck by the musician, is rigid or sufficiently elastic to vibrate to the stroke given (FIG. 1), is of any size or shape and is made out of rubber or any other kind of material that allows the musician to experience a rebound of the percussion instrument, such as when using drumsticks, as realistic as possible.

The bobbin (or vice versa the magnet) is be placed integral with the surface of the instrument, positioned beneath, at the side or even on top of the surface. The magnet is positioned inside the bobbin, or vice versa. The magnet can be positioned, for example, in two ways:

a) (FIG. 2) the magnet 12 is suspended within the bobbin 13 by elastic structures 14, the bobbin been applied in adherence to the upper surface 11 to be struck of the musical instrument;

b) (FIG. 3) the magnet 16 is integral with the upper surface 15 to be struck of the electronic musical instrument, but mechanically de-coupled from the bobbin 17, which is in turn integral with the lower surface 18, by means of rubber elements (19) that filter out most of the high frequency vibrations.

As soon as the upper surface 11, 15 of the electronic instrument is hit, a mechanical oscillation is created between the magnet 12, 16 and the bobbin 13, 17 with the relative generation of an electric tension at the poles of the bobbin.

An electronic circuit of analysis will be dedicated to the analysis of the form of electrical wave generated in order to extract the following standard information required by electronic percussion instruments:

a) the trigger, i.e. the determination of the event linked to the stroke of the drumstick or the hand of the musician on the struck surface of the electronic percussion musical instrument;

b) the amplitude of the signal resulting from the stroke that is proportional to the volume of the sound generated by the electronic control unit.

The physical principle is based on the relative movement (FIG. 4) between the magnet 20 and the bobbin 21 therefore, in the previous descriptions, the words ‘magnet’ and ‘bobbin’ can be changed without the invention losing validity or functionality.

In the previous descriptions the magnet can be replaced by a second bobbin: the functioning of the sensor remains unvaried.

The electronic percussion instrument system can use one or more FNL sensors individually or together with one or more piezoelectric sensors for a greater capability of vibration interpretation: all this to obtain electronic musical instruments resulting more and more similar to the real acoustic instruments.

The detection system just described is used for electronic musical instruments and, in particular but not only, for the electronic drum components.

In a tridimensional version, the new detection system of percussion in an electronic musical instrument (FIG. 5) consists of an upper surface 1 that receives the percussion, possibly covered by an elastic layer, for example rubber 2 useful for giving the musician the sensation of a realistic rebound (when the upper surface is multi layer and not single. The magnet 3 of the FNL sensor is applied in adherence to this upper surface and the bobbin 4 of the FNL sensor is applied to a lower surface 5, with a shock absorber spacer 6 between the two surfaces that allows the two components of the FNL sensor to remain in reciprocal suspension. These two components can also be inverted on the two surfaces.

1. An electronic percussion instrument system including:
an upper surface (15), flat, made from one or two layers of any rigid material, of any shape (e.g. round, oval, hexagonal, octagonal or any other geometrical form) that represents the percussion surface,
an electromagnetic FNL sensor, positioned beneath in the centre with its cylindrical magnet (16), is in adherence to the upper surface, while the bobbin (17) is positioned in correspondence to the magnet (16) on the lower surface (18),
a lower surface (18), flat, made up from one layer or plate of any rigid or elastic material with the same or different dimensions to the upper surface (15) on which the bobbin is positioned, being the second component of the FNL sensor,
a layer (19) of any shape, thickness or dimension, made out of an elastic material placed in adherence to the extremities of the two surfaces (15)(18).

2. An electronic percussion instrument as indicated in claim 1, where the upper surface (15) is made out of an elastic material, such as rubber, silicone or something else that is flexible, to moderate the percussion stroke and to guarantee a realistic rebound for the musician.

3. An electronic percussion instrument system as indicated in claim 1 where the upper surface (15) is made out of a synthetic skin material.

4. An electronic percussion instrument system as indicated in claims from 1 to 3 where the upper surface (15) is made out of a natural or synthetic material with holes or openings through which air passes.

5. An electronic percussion instrument system as indicated in claims from 1 to 4 where the upper surface (15) is made out of a multilayer, even different to one another, of a natural or synthetic or mixed natural or synthetic material with holes or openings through which air passes.

6. An electronic percussion instrument system as indicated in claims from 1 to 5 where the upper surface (15) is made out of a material with various interwoven layers of a natural or synthetic material, or various layers of natural or synthetic material with holes or openings through which air passes.

7. An electronic percussion instrument system as indicated in claims from 1 to 5 where the upper surface (15) is made out of various layers welded together by heat or cold, of a natural or synthetic material with holes or openings through which air passes.

8. An electronic percussion instrument system as indicated in claims from 1 to 7 where the FNL electromagnetic sensor is positioned inverting the magnet (16) and the bobbin (17) on the upper (15) and lower (18) surfaces.

9. An electronic percussion instrument system as indicated in claims from 1 to 8 where the upper (15) and lower (18) surfaces have a curvilinear shape.

10. An electronic percussion instrumental system as indicated in claims from 1 to 9 where the upper (15) surface of any material has a smooth, rough, wrinkly or dotted surface or furrowed with lines, stripes or has varying thicknesses or is made up from various portions adjacent to one another.

11. An electronic percussion instrument system as indicated in claims from 1 to 10 where the FNL electromagnetic sensor, magnet (17) and bobbin (18), is positioned in any place other than the centre of the two surfaces (15)(18).

12. An electronic percussion instrument system as indicated in claims from 1 to 11 where a number of FNL electromagnetic sensors, magnet (17) and bobbin (18) are applied.

13. An electronic percussion instrument system as indicated in claims from 1 to 12 where the magnet (16) and bobbin (17) have any other shape.

14. An electronic percussion instrument system as indicated in claims from 1 to 13 where the upper surface (15) and the lower (18) are not parallel to each other.

15. An electronic percussion instrument system as indicated in claims from 1 to 14 where the layer (17) of any shape, thickness or dimension is positioned in one or more points between the two surfaces (15)(18) and not necessarily at the extremities in an outer position.

16. An electronic percussion instrument system as indicated in claims from 1 to 14 where the layer (6) of any shape, thickness or dimension is positioned perimetrically between the two surfaces (1)(5) and not necessarily at the extremities.
